(19) United States
(12) Patent Application Publication
(10) Pub. No.: US 2018/0253520 A1
(43) Pub. Date: Sep. 6, 2018

(54) Methods And Systems For Numerically Simulating Structural Failure With Clusters Of Bonded Discrete Elements

(71) Applicant: Livermore Software Technology Corporation, Livermore, CA (US)

(72) Inventors: Boning Zhang, Livermore, CA (US); Hailong Teng, Livermore, CA (US); Chi-Hsien Wang, Livermore, CA (US)

(21) Appl. No.: 15/449,672

(22) Filed: Mar. 3, 2017

(51) Int. Cl. G06F 17/50

(52) U.S. Cl. CPC G06F 17/5018; G06F 2217/16

(57) ABSTRACT

Methods and systems for numerically simulating structural failure with clusters of bonded discrete elements representing a failed portion of the structure are disclosed. A computerized mesh model representing a structure is received in a computer system. The computerized mesh model containing at least a plurality of finite elements with a subgroup of adaptive elements included therein. A corresponding cluster of discrete elements and connecting bonds for each adaptive element are created based on a set of predefined criteria. The discrete elements and the connecting bonds are initially set to a state of pre-active, and connecting bonds are used for connecting discrete elements to one another within each cluster. Numerically-calculated structural behaviors are obtained by conducting a time-marching simulation for a predetermined duration in a plurality of solution cycles using the computerized mesh model with a scheme for processing the adaptive elements and corresponding clusters of discrete elements.

### FIELD

The invention generally relates to computer aided mechanical engineering analysis, more particularly to methods and systems for numerically simulating structural failure with clusters of bonded discrete elements representing a failed portion of the structure.

### BACKGROUND

Continuum mechanics has been used for simulating continuous matter such as solids and fluids (i.e., liquids and gases). Differential equations are employed in solving problems in continuum mechanics. Many numerical procedures have been used, including but not limited to, finite element method (FEM), meshfree methods such as discrete element method (DEM), Smoothed-particle Hydrodynamics (SPH), and etc.

To numerically simulate structural failure, one of the prior art approach is based on combined FEM/DEM with discrete elements representing a failed portion of a structure. However, a problem/drawback associated with the prior art approach is that discrete elements would scatter in the failed portion hence not simulating realistic physical phenomena. Therefore, it would be desirable to have improved methods that can more realistically use discrete elements to represent a failed portion of a structure in a numerical simulation of a structural failure.

### SUMMARY

This section is for the purpose of summarizing some aspects of the invention and to briefly introduce some preferred embodiments. Simplifications or omissions in this section as well as in the abstract and the title herein may be made to avoid obscuring the purpose of the section. Such simplifications or omissions are not intended to limit the scope of the invention.

Methods and systems for numerically simulating structural failure with clusters of bonded discrete elements representing a failed portion of the structure are disclosed. A method of numerically simulating structural failure comprises: a computerized mesh model representing a structure is received in a computer system having an application module installed thereon. The computerized mesh model contains at least a plurality of finite elements (e.g., solid elements in three-dimension) with a subgroup of adaptive elements included therein. A corresponding cluster of discrete elements and connecting bonds for each adaptive element are created based on a set of predefined criteria. With the application module, the discrete elements and the connecting bonds are initially set to a state of pre-active, and connecting bonds are used for connecting discrete elements to one another within each cluster. Numerically-calculated structural behaviors are obtained by conducting a time-marching simulation for a predetermined duration in a plurality of solution cycles using the computerized mesh model with a special scheme for processing the adaptive elements and corresponding clusters of discrete elements.

According to another aspect, the special scheme comprises the following actions: (a) obtaining element deformations and global displacements of all of the finite elements; (b) determining which of the finite elements has failed in accordance with plastic strains that are derived from the element deformations; (c) deleting each failed adaptive element from the computerized mesh model and changing the state of the discrete elements and the connecting bonds in the corresponding cluster from pre-active to active; (d) updating the pre-active discrete elements to reflect the global displacements and the element deformations of each of the adaptive elements; (e) performing contact computations amongst all of the active discrete elements and the finite elements, no contact occur within each of the clusters; and (f) repeating actions (a)-(e) for next solution cycle until the predetermined duration has reached or the end of numerical simulation.

Other objects, features, and advantages of the invention will become apparent upon examining the following detailed description of an embodiment thereof, taken in conjunction with the attached drawings.

### BRIEF DESCRIPTION OF THE DRAWINGS

These and other features, aspects, and advantages of the invention will be better understood with regard to the following description, appended claims, and accompanying drawings as follows:

FIGS. 1A-1B collectively show a flowchart illustrating an example process of numerically simulating structural failure with clusters of bonded discrete elements representing a failed portion of the structure, according to an embodiment of the invention;

FIG. 2 is a diagram showing an example computerized mesh model containing at least a plurality of finite elements with a subgroup of adaptive elements included therein, according to an embodiment of the invention;

FIG. 3A is a diagram showing a pair of example discrete elements with a connecting bond in accordance with an embodiment of the invention;

FIGS. 3B-3C are diagrams showing example two-dimensional adaptive elements in accordance with an embodiment of the invention;

FIGS. 3D-3E are diagrams showing example patterns of connecting bonds in a cluster according to an embodiment of the invention;

FIGS. 3F-3G are diagrams showing example three-dimensional adaptive elements, according to an embodiment of the invention;

FIG. 4 is a diagram showing global and local coordinate systems used for an example quadrilateral finite element;

FIG. 5 is a diagram depicting an example adaptive element in first and second positions, according to an embodiment of the invention;

FIGS. 6A-6D are diagrams illustrating a sequence of an example subgroup of adaptive elements undergoing structural failure in accordance with one embodiment of the invention;

FIGS. 7A-7B are diagrams showing contacts between example discrete elements and other discrete elements, and between example discrete elements and finite elements in accordance with an embodiment of the invention; and

FIG. 8 is a function diagram showing salient components of a computing device, in which an embodiment of the invention may be implemented.

### DETAILED DESCRIPTION

In the following description, numerous specific details are set forth in order to provide a thorough understanding of the invention. However, it will become obvious to those skilled in the art that the invention may be practiced without these specific details. The descriptions and representations herein are the common means used by those experienced or skilled in the art to most effectively convey the substance of their work to others skilled in the art. In other instances, well-known methods, procedures, components, and circuitry have not been described in detail to avoid unnecessarily obscuring aspects of the invention.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams representing one or more embodiments of the invention do not inherently indicate any particular order nor imply any limitations in the invention.

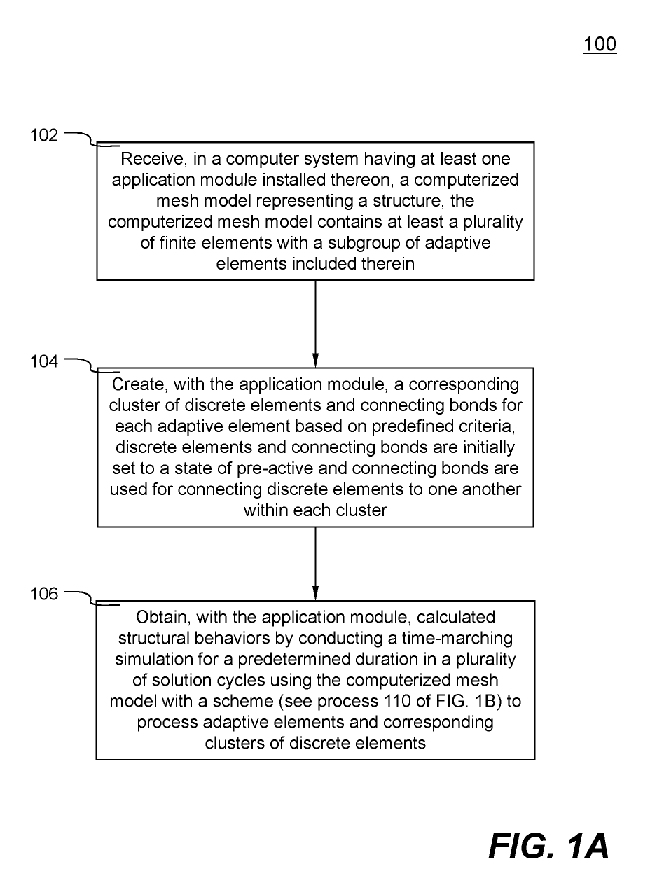

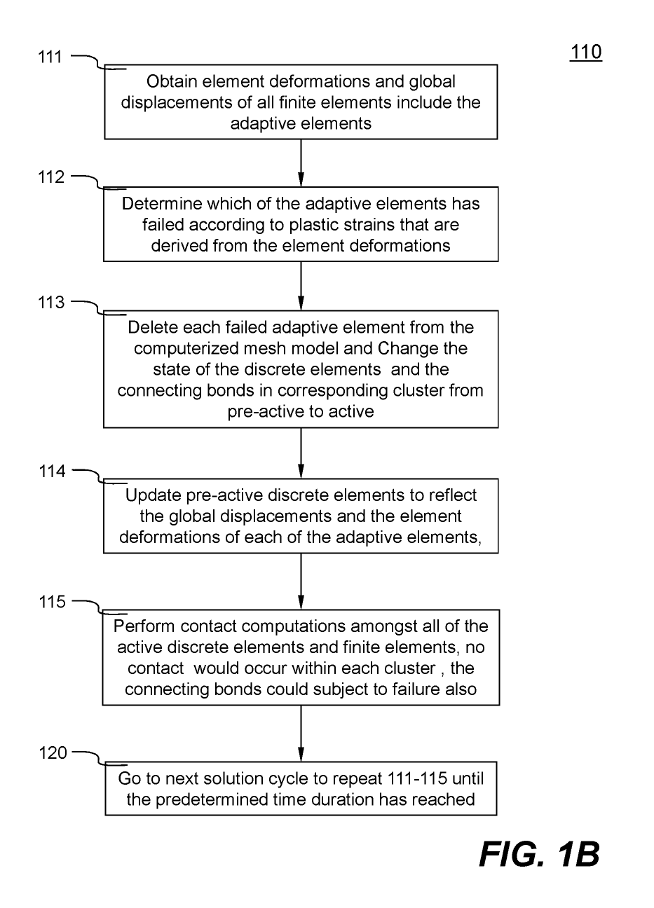

Embodiments of the invention are discussed herein with reference to FIGS. 1A-8. However, those skilled in the art will readily appreciate that the detailed description given herein with respect to these figures is for explanatory purposes as the invention extends beyond these limited embodiments.

Referring first to FIGS. 1A-1B, it is collectively shown a flowchart illustrating an example process 100 of numerically simulating structural failure in accordance with an embodiment of the invention. Process 100 is preferably implemented in software and understood with other figures.

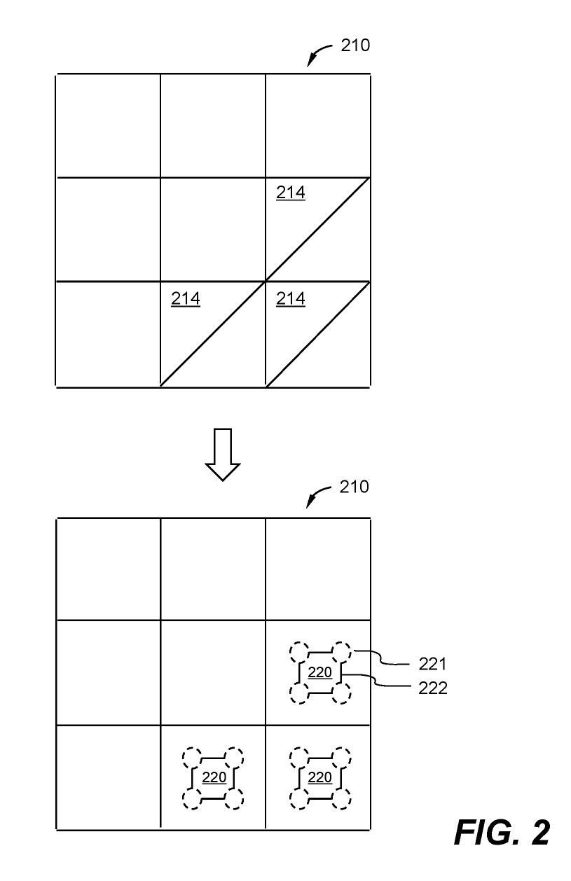

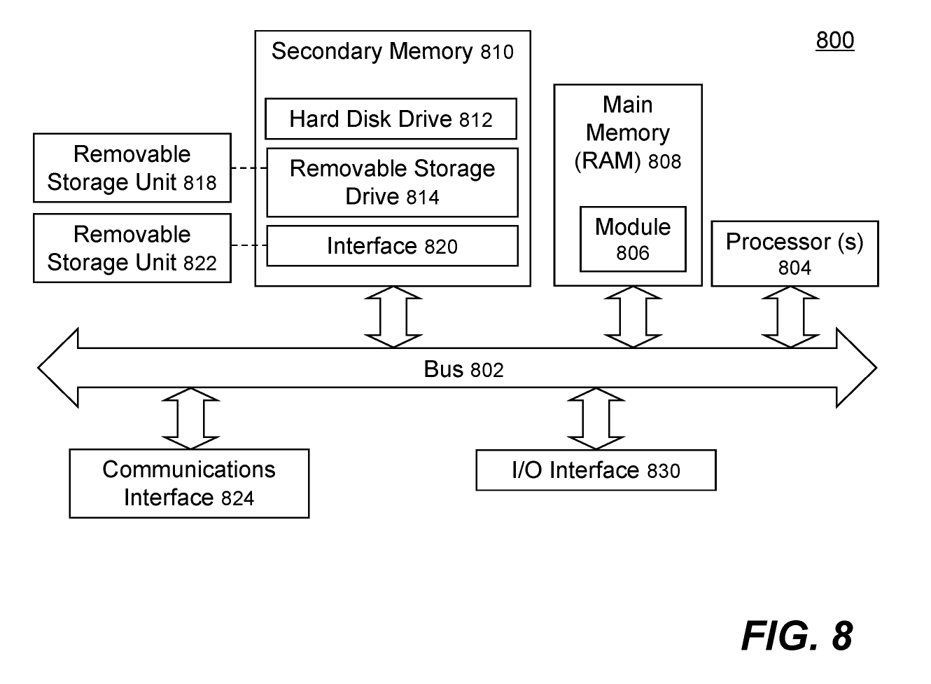

Process 100 starts at action 102 by receiving a computerized mesh model representing a structure in a computer system (e.g., computer system 800 of FIG. 8) having at least one application module installed thereon. Application module may be a software based on finite element method, discrete element method, etc. The computerized mesh model contains at least a plurality of finite elements. A subgroup of the finite elements are adaptive elements. FIG. 2 shows an example computerized mesh model 210 having nine finite elements with a subgroup of adaptive elements (elements with diagonal lines) 214. Each adaptive element 214 adapts from finite element to a corresponding cluster 220 of bonded discrete elements, when the finite element is determined to have failed in a numerical simulation (i.e., a time-marching simulation). In this example, each cluster 220 contains four discrete elements 221 (shown as dotted line circles) connected on another with four bonds 222. For illustration simplicity in this example, the computerized mesh model 210 is a two-dimensional model containing 4-node quadrilateral finite elements. Each adaptive element 214 is associated with a cluster 220 of four discrete elements 221. In another embodiment, other numbers of discrete elements may be used for each adaptive element (not shown) and bonds for connecting discrete elements may have different patterns (not shown).

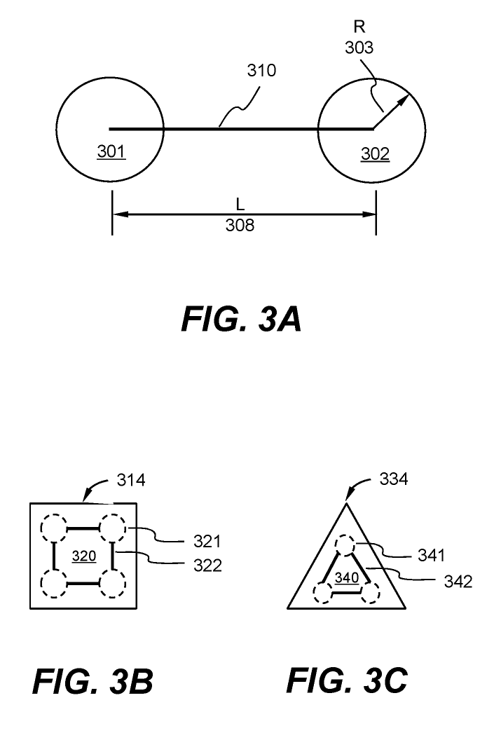

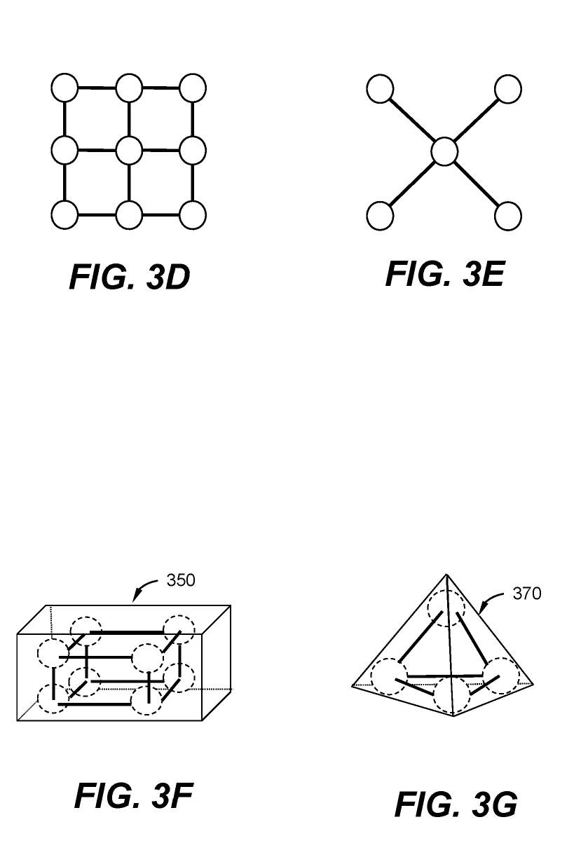

FIG. 3A shows a pair of example discrete elements 301-302 connected by a connecting bond 310. Each of the discrete elements 301-302 comprises a circle (in 2-D) or a sphere (in 3-D) with a radius R 303. Size and shape of each discrete elements can be calculated from the parent adaptive element. For example, each discrete element is assigned one fourth of the volume of a quadrilateral finite element. Assuming each discrete element comprises a circular or spherical shape, the radius R 303 can be calculated accordingly. The connecting bond 310 comprises a length L 308 from center-to-center of the pair of discrete elements 301-302. Each connecting bond 310 can be assigned material properties such as cross-section area and Young's modulus, thereby the connecting bond 310 could subject to material failure when the connecting bond is in an active state. In order for illustration clarity, the connecting bonds are not drawn to the center of discrete elements in other figures.

FIG. 3B shows a quadrilateral adaptive element 314 with corresponding cluster 320 of four discrete elements 321, and FIG. 3C shows a triangular adaptive element 334 with corresponding cluster 340 of three discrete elements 342. Discrete elements 321 in the quadrilateral element 314 are bonded into a cluster 320 with bonds 322. Discrete elements 341 in the triangular element 334 are bonded with bonds 342. In another embodiment, other numbers of discrete elements and different patterns of connecting bonds are used. For example, FIG. 3D shows a cluster of nine discrete elements. FIG. 3E shows a cluster of five discrete elements connected to one another via four connecting bonds.

Whereas the examples shown have been in two-dimensional space, the invention does not limit to two-dimensional model. For example, a computerized mesh model can be a three-dimensional model comprising solid elements (e.g., hexahedral element 350 shown in FIG. 3F, tetrahedral element 370 shown in FIG. 3G).

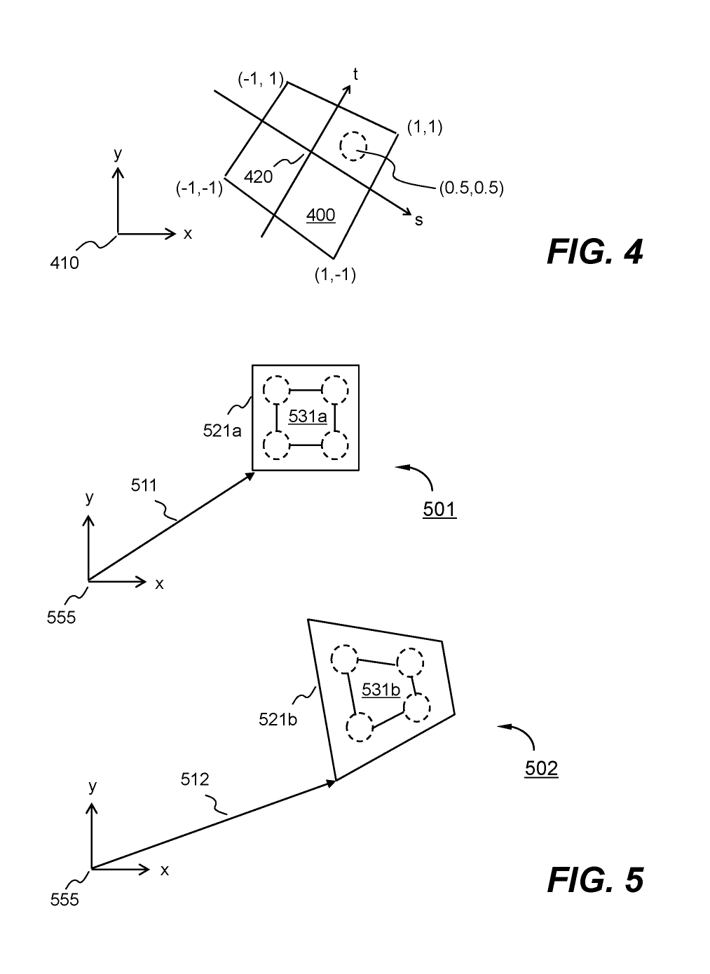

Next, at action 104, a corresponding cluster of discrete elements and connecting bonds are created for each adaptive element based on predetermined criteria. The discrete elements and the connecting bonds are initially set to a state of pre-active. Connecting bonds are used for connecting discrete elements to one another within each cluster. A set of predetermined criteria may include, but are not limited to, the number of discrete elements and locations of the discrete elements within corresponding adaptive element, size and shape of the discrete elements, a particular pattern of connecting bonds, material properties of the connecting bonds, etc. The locations of discrete elements are generally defined in an element local coordinate system, for example, an element local coordinate system (s-t) 420 for an example quadrilateral element 400 shown in FIG. 4. The element local coordinate system (s-t) 420 is dimensionless and configured such that the coordinates at four corners of the quadrilateral element 400 are unity either 1 or −1.

In addition, a global coordinate system (x-y) 410 used for defining the geometry of the computerized mesh model is also shown. Locations of the discrete elements can be defined in a local coordinate system as an s-t pair, for example, (0.5,0.5), (0.5, −0.5), etc.

Then, at action 106, numerically calculated structural behaviors are obtained by conducting a time-marching simulation using the computerized mesh model. Time-marching simulation is to numerically simulate structural behaviors for a predetermined time duration in a number of solution cycles. In other words, at each solution cycle, the structural behaviors at a particular time within the time duration are calculated and obtained. The particular time is an increment to the time at previous solution cycle. For processing adaptive elements and corresponding clusters of discrete elements in the time-marching simulation, a special scheme (details shown in process 110 of FIG. 1B) is used.

At action 111, process 110 obtains local element forces, element deformations and global displacements of all finite elements including the adaptive elements in the computerized mesh model (e.g., via finite element method) at each solution cycle of the time-marching simulation. FIG. 5 shows an example adaptive element 521a-521b at a first position 501 and at a second position 502 in a global coordinate system 555. The first position 501 is ahead of the second position 502 in time. In other words, the second position 502 occurs after the first position 501. Adaptive element 521a contains a corresponding cluster 531a of bonded discrete elements. Vector 511 represents a global displacement of adaptive element 521a. At the second position 502, a deformed adaptive element 521b having corresponding cluster 531b of discrete elements.

At action 112, process 110 determines which of the adaptive elements has failed in accordance with plastic strains that are derived from the obtained element deformations at action 111 and a set of material failure rules. Next, at action 113, each failed adaptive element is deleted from the computerized mesh model and the state of the discrete elements and the connecting bonds in corresponding cluster are changed from pre-active to active at action.

Then, at action 114, the remaining of the pre-active discrete elements are updated to reflect the global displacements and the element deformations of each adaptive element. At the pre-active state, the connecting bonds are not assigned any forces.

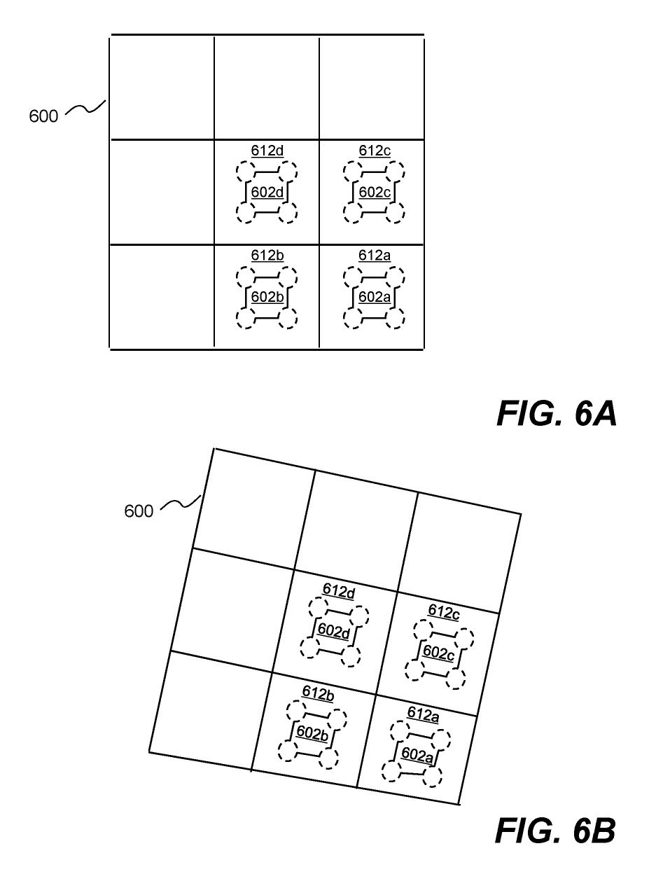

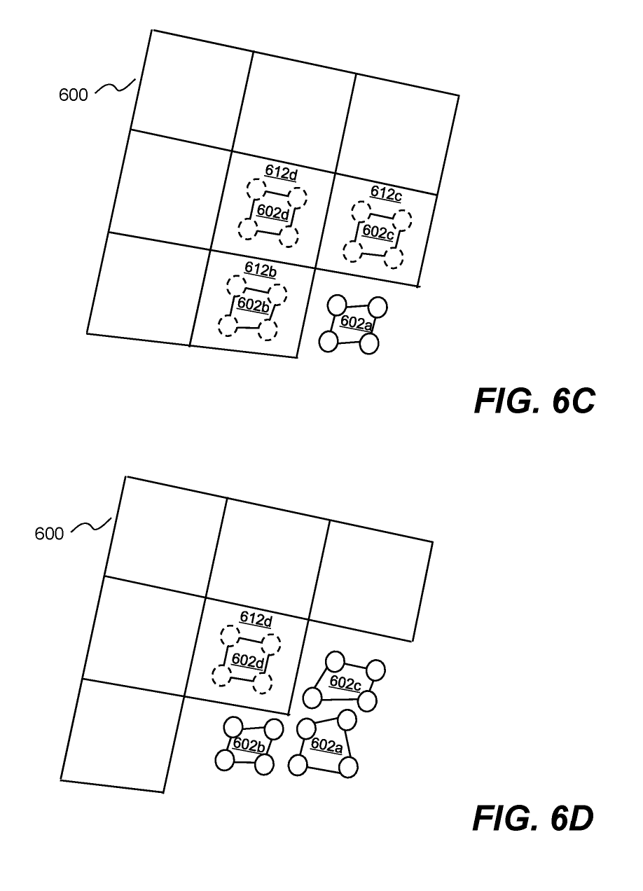

FIGS. 6A-6D show a sequence of an example subgroup of adaptive elements undergoing structural failure in accordance with an embodiment of the invention. A computerized mesh model 600 contains a subgroup of adaptive elements 612a-612d. FIG. 6A shows an initial position with all clusters of discrete elements 602a-602d set to pre-active state (shown as dotted line circles). FIG. 6B shows a deformed position with all adaptive elements 612a-612d intact thereby the state of corresponding discrete elements unchanged as pre-active. After structural failure occurs, FIG. 6C shows adaptive element 612a has been deleted from the computerized mesh model 600 and the state of the corresponding cluster 602a of discrete elements has been changed to active (shown as solid line circles). FIG. 6D shows more adaptive elements 612b-612c have been deleted and more clusters 602b-602d have been activated (i.e., the state of discrete elements changed from pre-active to active).

At action 115, contact computations are performed amongst all of the active discrete elements and finite elements. No contact would occur within each cluster. In some embodiment, connecting bonds could subject to material failure. After such a failure of the connecting bonds, the discrete elements would become free of the constraint of a cluster.

Contact computations can be performed with a number of well-known techniques to detect contacts between two or more portions of a structure (represented by computerized mesh model). After each contact is detected, a corresponding contact force is then calculated and applied to the portions involved in the contact.

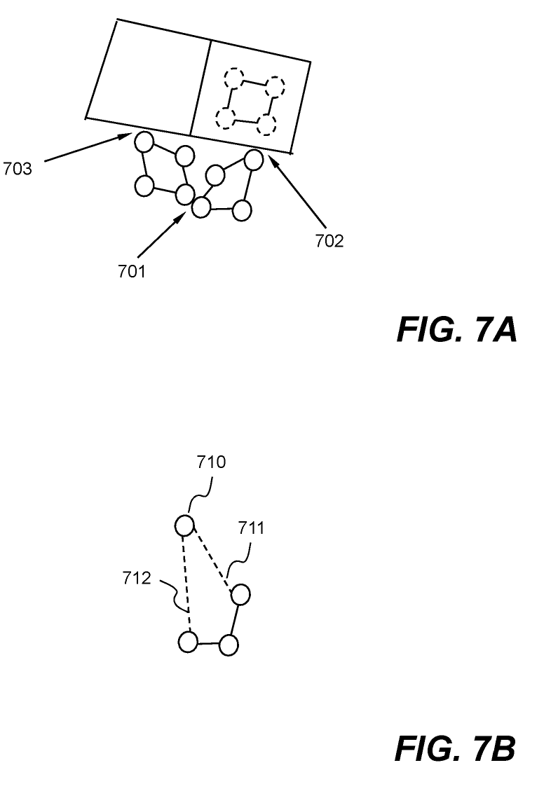

FIG. 7A is a diagram showing contacts between example discrete elements and other discrete elements (e.g., location 701), and between example discrete elements and finite elements (e.g., locations 702-703) in accordance with an embodiment of the invention. It is noted that discrete elements within each cluster are connected together. FIG. 7B shows one example discrete element 710 is free from the constraints of a cluster due to failure of the connecting bonds 711-712 (shown as dotted lines).

Finally, at action 120, process 110 repeats actions 111-115 for the next solution cycle until the time duration has reached and the time-marching simulation ends thereafter.

According to one aspect, the invention is directed towards one or more computer systems capable of carrying out the functionality described herein. An example of a computer system 800 is shown in FIG. 8. The computer system 800 includes one or more processors, such as processor 804. The processor 804 is connected to a computer system internal communication bus 802. Various software embodiments are described in terms of this exemplary computer system. After reading this description, it will become apparent to a person skilled in the relevant art(s) how to implement the invention using other computer systems and/or computer architectures.

Computer system 800 also includes a main memory 808, preferably random access memory (RAM), and may also include a secondary memory 810. The secondary memory 810 may include, for example, one or more hard disk drives 812 and/or one or more removable storage drives 814, representing a floppy disk drive, a magnetic tape drive, an optical disk drive, etc. The removable storage drive 814 reads from and/or writes to a removable storage unit 818 in a well-known manner. Removable storage unit 818, represents a floppy disk, magnetic tape, optical disk, etc. which is read by and written to by removable storage drive 814. As will be appreciated, the removable storage unit 818 includes a computer usable storage medium having stored therein computer software and/or data.

In alternative embodiments, secondary memory 810 may include other similar means for allowing computer programs or other instructions to be loaded into computer system 800. Such means may include, for example, a removable storage unit 822 and an interface 820. Examples of such may include a program cartridge and cartridge interface (such as that found in video game devices), a removable memory chip (such as an Erasable Programmable Read-Only Memory (EPROM), Universal Serial Bus (USB) flash memory, or PROM) and associated socket, and other removable storage units 822 and interfaces 820 which allow software and data to be transferred from the removable storage unit 822 to computer system 800. In general, Computer system 800 is controlled and coordinated by operating system (OS) software, which performs tasks such as process scheduling, memory management, networking and I/O services.

There may also be a communications interface 824 connecting to the bus 802. Communications interface 824 allows software and data to be transferred between computer system 800 and external devices. Examples of communications interface 824 may include a modem, a network interface (such as an Ethernet card), a communications port, a Personal Computer Memory Card International Association (PCMCIA) slot and card, etc. Software and data transferred via communications interface 824. The computer 800 communicates with other computing devices over a data network based on a special set of rules (i.e., a protocol). One of the common protocols is TCP/IP (Transmission Control Protocol/Internet Protocol) commonly used in the Internet. In general, the communication interface 824 manages the assembling of a data file into smaller packets that are transmitted over the data network or reassembles received packets into the original data file. In addition, the communication interface 824 handles the address part of each packet so that it gets to the right destination or intercepts packets destined for the computer 800. In this document, the terms “computer program medium”, “computer readable medium”, “computer recordable medium” and “computer usable medium” are used to generally refer to media such as removable storage drive 814 (e.g., flash storage drive), and/or a hard disk installed in hard disk drive 812. These computer program products are means for providing software to computer system 800. The invention is directed to such computer program products.

The computer system 800 may also include an input/output (I/O) interface 830, which provides the computer system 800 to access monitor, keyboard, mouse, printer, scanner, plotter, and alike.

Computer programs (also called computer control logic) are stored as application modules 806 in main memory 808 and/or secondary memory 810. Computer programs may also be received via communications interface 824. Such computer programs, when executed, enable the computer system 800 to perform the features of the invention as discussed herein. In particular, the computer programs, when executed, enable the processor 804 to perform features of the invention. Accordingly, such computer programs represent controllers of the computer system 800.

In an embodiment where the invention is implemented using software, the software may be stored in a computer program product and loaded into computer system 800 using removable storage drive 814, hard drive 812, or communications interface 824. The application module 806, when executed by the processor 804, causes the processor 804 to perform the functions of the invention as described herein.

The main memory 808 may be loaded with one or more application modules 806 (e.g., FEM and/or DEM application module) that can be executed by one or more processors 804 with or without a user input through the I/O interface 830 to achieve desired tasks. In operation, when at least one processor 804 executes one of the application modules 806, the results are computed and stored in the secondary memory 810 (i.e., hard disk drive 812). The status of the analysis is reported to the user via the I/O interface 830 either in a text or in a graphical representation upon user's instructions.

Although the invention has been described with reference to specific embodiments thereof, these embodiments are merely illustrative, and not restrictive of, the invention. Various modifications or changes to the specifically disclosed exemplary embodiments will be suggested to persons skilled in the art. For example, whereas most of the examples have been described and shown as two-dimension quadrilateral element, other types of elements can be used, for example, three-dimensional solid elements (hexahedral and/or tetrahedral elements) to accomplish the same. Additionally, one particular pattern of cluster of discrete elements have been described and shown, other patterns may be used to achieve the same. In summary, the scope of the invention should not be restricted to the specific exemplary embodiments disclosed herein, and all modifications that are readily suggested to those of ordinary skill in the art should be included within the spirit and purview of this application and scope of the appended claims.

We claim:

1. A method of numerically simulating structural failure comprising:
receiving, in a computer system having at least one application module installed thereon, a computerized mesh model representing a structure, the computerized mesh model containing at least a plurality of finite elements with a subgroup of adaptive elements included therein;
creating, with the application module, a corresponding cluster of discrete elements and connecting bonds for each adaptive element based on a set of predefined criteria, the discrete elements and the connecting bonds being initially set to a state of pre-active, and the connecting bonds being used for connecting the discrete elements to one another within each cluster; and
obtaining, with the application module, numerically-calculated structural behaviors by conducting a time-marching simulation for a predetermined duration in a plurality of solution cycles using the computerized mesh model with a scheme for processing the adaptive elements and corresponding clusters of discrete elements, the scheme comprises following actions:
(a) obtaining element deformations and global displacements of all of the finite elements;
(b) determining which of the finite elements has failed in accordance with plastic strains that are derived from the element deformations;
(c) deleting each failed adaptive element from the computerized mesh model and changing the state of the discrete elements and the connecting bonds in the corresponding cluster from pre-active to active;
(d) updating the pre-active discrete elements to reflect the global displacements and the element deformations of each of the adaptive elements;
(e) performing contact computations amongst all of the active discrete elements and the finite elements, whereby no contact would occur within each of the clusters and the active bonds could subject to material failure; and
(f) repeating (a)-(e) for next solution cycle until the predetermined duration has reached.

2. The method of claim 1, wherein the predefined criteria include total number of discrete elements within each cluster and a size of each discrete element.

3. The method of claim 2, wherein the predefined criteria further include a particular pattern of the connecting bonds.

4. The method of claim 3, wherein the predefined criteria further include locations of discrete elements within each adaptive element.

5. The method of claim 2, wherein each discrete element comprises a sphere with a radius as the size.

6. The method of claim 1, wherein the predefined criteria include assigning material properties of the connecting bonds.

7. The method of claim 1, wherein the finite elements comprise hexahedral elements.

8. The method of claim 1, wherein the finite elements comprise tetrahedral elements.

9. A system for numerically simulating structural failure comprising:
a memory for storing computer readable code for at least one application module;
at least one processor coupled to the memory, said at least one processor executing the computer readable code in the memory to cause the application module to perform operations of:
receiving a computerized mesh model representing a structure, the computerized mesh model containing at least a plurality of finite elements with a subgroup of adaptive elements included therein;
creating a corresponding cluster of discrete elements and connecting bonds for each adaptive element based on a set of predefined criteria, the discrete elements and the connecting bonds being initially set to a state of pre-active, and the connecting bonds being used for connecting the discrete elements to one another within each cluster; and
obtaining numerically-calculated structural behaviors by conducting a time-marching simulation for a predetermined duration in a plurality of solution cycles using the computerized mesh model with a scheme for processing the adaptive elements and corresponding clusters of discrete elements, the scheme comprises following actions:
(a) obtaining element deformations and global displacements of all of the finite elements;
(b) determining which of the finite elements has failed in accordance with plastic strains that are derived from the element deformations;
(c) deleting each failed adaptive element from the computerized mesh model and changing the state of the discrete elements and the connecting bonds in the corresponding cluster from pre-active to active;
(d) updating the pre-active discrete elements to reflect the global displacements and the element deformations of each of the adaptive elements;
(e) performing contact computations amongst all of the active discrete elements and the finite elements, whereby no contact would occur within each of the clusters and the active bonds could subject to failure; and
(f) repeating (a)-(e) for next solution cycle until the predetermined duration has reached.

10. The system of claim 9, wherein the predefined criteria include total number of discrete elements within each cluster and a size of each discrete element.

11. The system of claim 10, wherein the predefined criteria further include a particular pattern of the connecting bonds.

12. The system of claim 11, wherein the predefined criteria further include locations of discrete elements within each adaptive element.

13. The system of claim 10, wherein each discrete element comprises a sphere with a radius as the size.

14. The system of claim 9, wherein the predefined criteria include assigning material properties of the connecting bonds.

15. A non-transitory computer readable medium containing instructions for numerically simulating structural failure, by a method comprising:
receiving, in a computer system having at least one application module installed thereon, a computerized mesh model representing a structure, the computerized mesh model containing at least a plurality of finite elements with a subgroup of adaptive elements included therein;
creating, with the application module, a corresponding cluster of discrete elements and connecting bonds for each adaptive element based on a set of predefined criteria, the discrete elements and the connecting bonds being initially set to a state of pre-active, and the connecting bonds being used for connecting the discrete elements to one another within each cluster; and
obtaining, with the application module, numerically-calculated structural behaviors by conducting a time-marching simulation for a predetermined duration in a plurality of solution cycles using the computerized mesh model with a scheme for processing the adaptive elements and corresponding clusters of discrete elements, the scheme comprises following actions:
(a) obtaining element deformations and global displacements of all of the finite elements;
(b) determining which of the finite elements has failed in accordance with plastic strains that are derived from the element deformations;
(c) deleting each failed adaptive element from the computerized mesh model and changing the state of the discrete elements and the connecting bonds in the corresponding cluster from pre-active to active;
(d) updating the pre-active discrete elements to reflect the global displacements and the element deformations of each of the adaptive elements;
(e) performing contact computations amongst all of the active discrete elements and the finite elements, whereby no contact would occur within each of the clusters and the active bonds could subject to failure; and
(f) repeating (a)-(e) for next solution cycle until the predetermined duration has reached.

16. The non-transitory computer readable medium of claim 15, wherein the predefined criteria include total number of discrete elements within each cluster and a size of each discrete element.

17. The non-transitory computer readable medium of claim 16, wherein the predefined criteria further include a particular pattern of the connecting bonds.

18. The non-transitory computer readable medium of claim 17, wherein the predefined criteria further include locations of discrete elements within each adaptive element.

19. The non-transitory computer readable medium of claim 16, wherein each discrete element comprises a sphere with a radius as the size.

20. The non-transitory computer readable medium of claim 15, wherein the predefined criteria include assigning material properties of the connecting bonds.
